(19) United States
(12) Patent Application Publication
(10) Pub. No.: US 2009/0165470 A1
(43) Pub. Date: Jul. 2, 2009

(54) CRYOPUMP, CRYOPUMP UNIT, VACUUM PROCESSING APPARATUS INCLUDING CRYOPUMP UNIT, AND CRYOPUMP REGENERATION METHOD

(75) Inventors: Kazutoshi Aoki, Minamitsuru-gun (JP); Takahiro Okada, Minamitsuru-gun (JP)

Correspondence Address: FITZPATRICK CELLA HARPER & SCINTO, 30 ROCKEFELLER PLAZA, NEW YORK, NY, 10112, US

(73) Assignee: CANON ANELVA TECHNIX CORPORATION, Kawasaki-shi (JP)

(21) Appl. No.: 12/339,808

(22) Filed: Dec. 19, 2008

(30) Foreign Application Priority Data
Dec. 27, 2007 (JP) 2007-337385

(51) Int. Cl. F04B 37/08; F04B 37/00; B01D 1/30

(52) U.S. Cl. 62/55.5; 62/268; 417/901; 165/95

(57) ABSTRACT

A cryopump regeneration method includes a temperature raising step of raising the temperature of a cryopanel so as to vaporize gas molecules condensed on the exhaust surface of the cryopanel, an evacuation step of evacuating a pump vessel, a determination step of determining whether the internal pressure of the pump vessel has reached a set pressure higher than the water vapor pressure at 0° C., a pressure rise test step of stopping the evacuation and performing a pressure rise test, and an observation step of observing residual water based on the internal pressure of the pump vessel.

### BACKGROUND OF THE INVENTION

1. Field of the Invention

The present invention relates to a cryopump, a cryopump unit, a vacuum processing apparatus including the cryopump unit, and a cryopump regeneration method and, more particularly, to a cryopump suitable for shortening the regeneration time and a regeneration method therefor.

2. Description of the Related Art

A cryopump is known in which a member (cryopanel) maintained at a low temperature is provided in a pump vessel and a gas containing water is vacuum-exhausted by condensing or adsorbing it on the surface (exhaust surface) of this member. In this cryopump, a regeneration process for exhausting a gas condensed in the pump to the outside of the pump vessel so as to recover the exhaust capacity of the cryopump is required. A conventional technique for shortening the time (regeneration time) required for the regeneration process of the cryopump is described in, for example, Japanese Patent Laid-Open No. 6-346848.

Japanese Patent Laid-Open No. 6-346848 discloses a technique about a cryopump regeneration method. In this regeneration method, a pump vessel is evacuated by a vacuum pump while forcibly raising the temperature of a cryopanel by introducing an inert gas (purge gas) such as nitrogen gas into the pump vessel, so as to maintain the pressure in the cryopump vessel to a pressure lower than the saturation vapor pressure of a gas having a lowest saturation vapor pressure of the gases condensed on the cryopanel.

In a cryopump described in Japanese Patent Laid-Open No. 6-33872, upon regenerating the cryopump by introducing/exhausting an inert gas such as nitrogen gas into/from the pump vessel, a step of detecting a change in water content in a pump vessel is performed. With this step, when water content remains in the pump vessel upon exhausting the inert gas, it is detected in the exhausted inert gas. Accordingly, it is possible to know whether the inside of the pump vessel has been dried based on a change in the detected water content.

In a cryopump described in Japanese Patent Laid-Open No. 9-14133, the process advances from a step of introducing a purge gas into a pump vessel to a step of evacuating the pump vessel by a vacuum pump when the temperature of a cryopanel has become equal to or more than a temperature at which water molecules vaporize. For this operation, a temperature sensor for detecting the temperature of the cryopanel is provided. Temperature information detected by the temperature sensor is sent to a regeneration processing control device. The regeneration processing control device receives the temperature information and performs the above-described regeneration method.

This regeneration method will be described in more detail. When the temperature of the cryopanel has become equal to or more than a temperature at which water vaporizes, the process advances from the purge gas introduction step to the evacuation step by the vacuum pump. This evacuation step is performed until the pressure in the pump vessel reaches a predetermined pressure. When the time required for reducing a reference pressure to the predetermined pressure is longer than a set time, it is determined that the regeneration is insufficient, and the instruction to introduce the purge gas is given again.

As described above, according to the cryopump described in Japanese Patent Laid-Open No. 9-14133, the temperature of the cryopanel is monitored and the pump vessel is repeatedly evacuated using a purge gas containing a large amount of water vapor. With this operation, the regeneration time is shortened.

A regeneration technique disclosed in Japanese Patent Laid-Open No. 6-346848 is more efficient than a technique of vaporizing a gas condensed on an exhaust surface only by introducing a purge gas for a long time, since it forcibly vaporizes the gas by performing evacuation by a vacuum pump. However, when the water decreases in temperature due to heat of vaporization and turns into ice, its vaporization efficiency significantly decreases.

According to Japanese Patent Laid-Open No. 6-33872, a step of detecting a change in water content in a pump vessel is performed upon regeneration of a cryopump. A water content detection unit is provided on the exhaust side of a gas exhaust valve of a gas exhaust tube. The water content detection unit detects water contained in an exhausted gas (for example, the humidity level of introduced nitrogen as illustrated in FIG. 2 of Japanese Patent Laid-Open No. 6-33872) and detects whether the inside of the pump has been completely dried, based-on the change in water content.

With the structure described in Japanese Patent Laid-Open No. 6-33872, however, whether the water remaining in the pump vessel is in a liquid state or not cannot be detected. Furthermore, with the cryopump regeneration method described in Japanese Patent Laid-Open No. 6-33872, the pressure in the pump vessel is not reduced by an evacuation device until it is detected that all the water vapor has been exhausted. Therefore, the regeneration time cannot be shortened by that amount.

Furthermore, according to the cryopump described in Japanese Patent Laid-Open No. 9-14133, the temperature of the cryopanel is monitored and the pump vessel is repeatedly evacuated using a purge gas containing a large amount of water vapor. With this operation, the regeneration time is shortened. However, the following problem arises.

Whether or not to reintroduce a purge gas into the pump vessel is determined during the operation of a vacuum pump and at a pressure lower than the water vapor pressure at 0° C. In addition, when the pump vessel is evacuated again after the pressure in the pump vessel has reached a predetermined pressure by reintroducing the purge gas, whether water exists in a liquid state or not is not considered at all. Therefore, when the cryopump stores a large amount of water on its exhaust surface, the water may remain in the cryopump as ice upon performing regeneration. As a result, when the evacuation of the cryopump is continued while the water remains therein, a considerably long time is required for reducing the pressure.

### SUMMARY OF THE INVENTION

In consideration of the above-described problems, the present invention has as its object to provide a cryopump which can shorten the regeneration time by evacuating a pump vessel while preventing residual water in a liquid state in the pump vessel from solidifying in a regeneration process, and a regeneration method therefor.

According to one aspect of the present invention, there is provided a regeneration method which is performed in a cryopump including a pump vessel, a cryopanel arranged in the pump vessel, and a refrigerator for cooling the cryopanel, and performs exhaustion by condensing gas molecules containing water vapor on the cryopanel, comprising

a temperature raising step of raising a temperature of the cryopanel so as to vaporize the gas molecules condensed on the cryopanel and discharge them in the pump vessel,

an evacuation step of performing evacuation based on a temperature condition of the cryopanel,

a determination step of determining whether a pressure of an interior of the pump vessel has reached a set pressure higher than a water vapor pressure at 0° C.,

a pressure rise test step of stopping the evacuation and performing a pressure rise test when it is determined that the pressure of the interior of the pump vessel has reached the set pressure in the determination step, and

an observation step of observing residual water based on an internal pressure of the pump vessel during the pressure rise test step.

In the above-described cryopump regeneration method, there are provided a determination step of determining whether the internal pressure of the pump vessel has reached a set pressure higher than the water vapor pressure at 0° C., and a pressure rise test step of stopping evacuation and performing a pressure rise test when it is determined in the determination step that the internal pressure of the pump vessel has reached the set pressure higher than the water vapor pressure at 0° C. Accordingly, even when water remains in the pump vessel, the water in a liquid state is observed. With this operation, it becomes possible to accurately and rapidly know whether water remains.

According to another aspect of the present invention, there is provided a cryopump including a pump vessel, a cryopanel arranged in the pump vessel, a refrigerator for cooling the cryopanel, a vacuum gauge for detecting an internal pressure of the pump vessel, and control means for controlling operations of the overall cryopump, and performing vacuum evacuation of a target apparatus by condensing gas molecules containing water on the cryopanel, wherein the control means comprises:

determination means for determining whether the internal pressure of the pump vessel has reached a set pressure higher than a water vapor pressure at 0° C. based on detection information of the vacuum gauge, at a stage of regeneration processing for raising a temperature of the cryopanel, vaporizing the gas molecules condensed on the cryopanel and discharging them in the pump vessel, and performing evacuation based on a temperature condition of the cryopanel;

test performing means for stopping the evacuation and performing a pressure rise test when it is determined by the determination means that the internal pressure has reached the set pressure; and

observation means for observing residual water based on the internal pressure of the pump vessel during the pressure rise test.

The above-described cryopump is arranged to detect whether water remaining in the pump vessel is in a liquid state or not and perform evacuation by the vacuum pump when the internal pressure of the pump vessel is higher than the water vapor pressure at 0° C. In the regeneration of the cryopump, upon performing evacuation by the vacuum pump after a purge gas is introduced into the pump vessel, evacuation by the vacuum pump is stopped when the pressure in the pump vessel has reached a set pressure higher than the water vapor pressure at 0° C., that is, before water solidifies into ice, and a temporal change in pressure in the pump vessel is measured. Based on the measurement result, the presence/absence of water in a liquid state in the pump vessel is determined.

When it is determined that water in a liquid state remains in the pump vessel, the temperature in the pump vessel is raised by introducing a drying purge gas or the like again so as to prompt the vaporization of the water.

According to the present invention, in the regeneration processing operation of the cryopump, the evacuation of the pump vessel is stopped when the pressure in the pump vessel has reached a set pressure higher than the water vapor pressure at 0° C., and a pressure rise test (measurement of pressure rise with respect to time) is performed. With this operation, the water vapor pressure in the pump vessel can be measured while no ice exists in the pump vessel. Accordingly, it is possible to accurately observe and ensure the presence/absence of the residual water in a liquid state in the pump vessel.

According to the present invention, since it is possible to always keep the water in the pump vessel of the cryopump in a gaseous or liquid state during the regeneration processing, the water in the pump vessel can be always exhausted in a gaseous or liquid state. As the residual water is a liquid and a large amount of water can be vaporized for the amount of energy provided, it is possible to vaporize the water in a short time, and therefore the regeneration time of the cryopump can be shortened.

Further features of the present invention will become apparent from the following description of exemplary embodiments with reference to the attached drawings.

### BRIEF DESCRIPTION OF THE DRAWINGS

FIG. 1 is a view showing the overall structure of a representative embodiment of a cryopump according to the present invention;

FIG. 2 is a flowchart illustrating the regeneration processing operation of the cryopump according to this embodiment; and

FIG. 3 is a graph showing how a pressure rises in a pressure rise test when it is performed repeatedly.

### DESCRIPTION OF THE EMBODIMENTS

A preferred embodiment of the present invention will be described below with reference to the accompanying drawings.

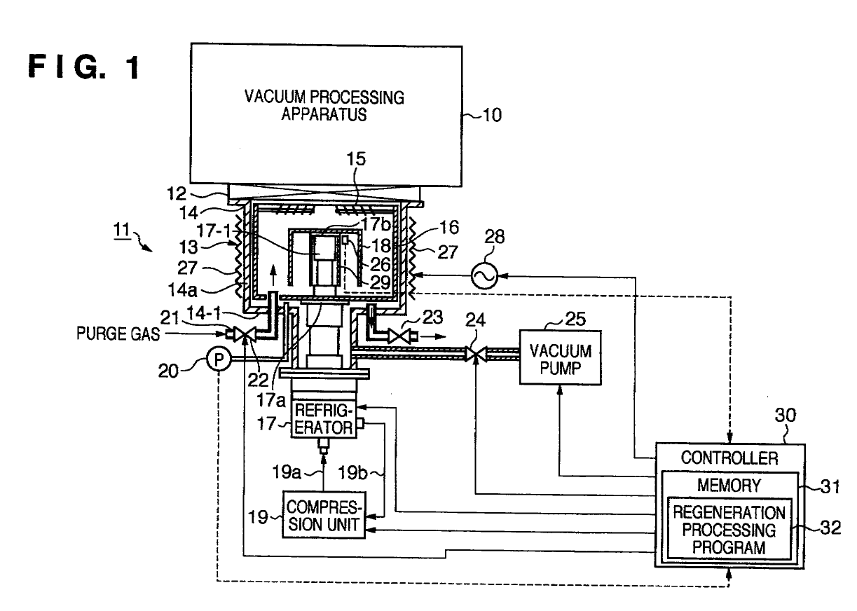

With reference to FIGS. 1 to 3, a cryopump unit including a cryopump according to an embodiment of the present invention and a regeneration method of the cryopump will be described.

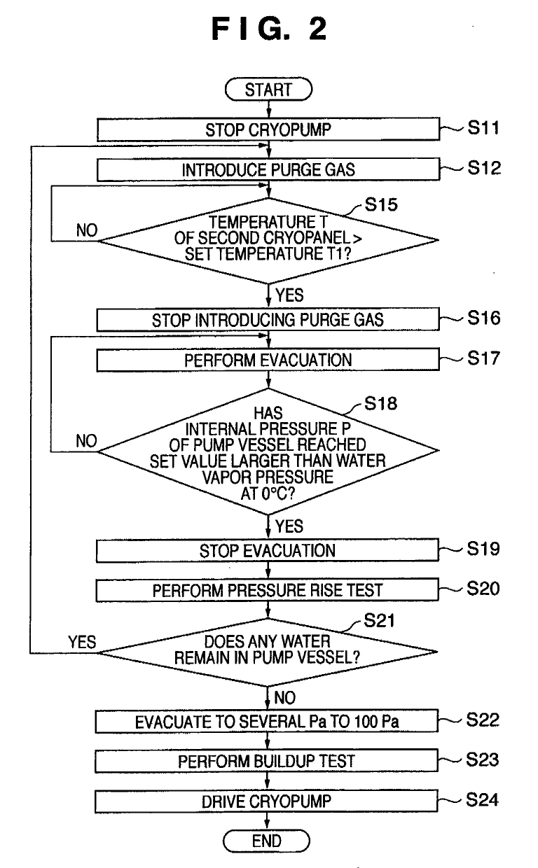

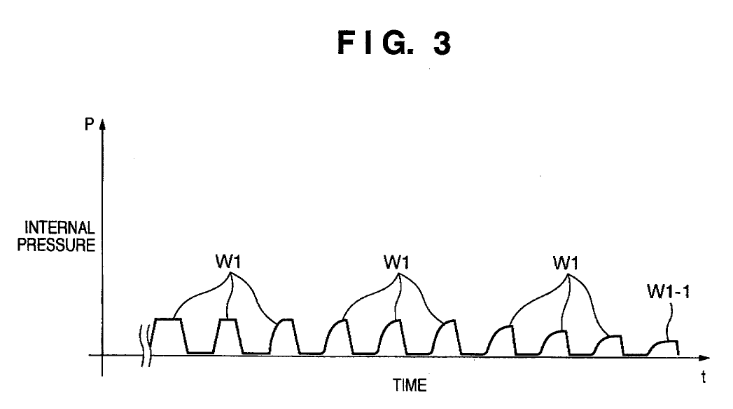

FIG. 1 is a view schematically showing the structure of an overall cryopump unit, FIG. 2 is a flowchart illustrating a regeneration operation, and FIG. 3 illustrates changes in the pressure in the pump vessel of a cryopump during the regeneration operation.

Referring to FIG. 1, a block denoted by reference numeral 10 represents a vacuum processing apparatus which undergoes vacuum evacuation using a cryopump unit including a cryopump according to an embodiment of the present invention. A cryopump unit 11 is provided under the vacuum processing apparatus 10. A pump vessel 14 of a cryopump 13 is connected to an exhaust port (not shown) provided in the lower portion of the vacuum processing apparatus 10 via a main valve 12.

The overall vacuum evacuation operation of the vacuum processing apparatus 10 based on the cryopump unit 11 is controlled by a controller 30 (to be also referred to as “control device 30” hereinafter).

FIG. 1 shows a longitudinal sectional view of the internal structure of the pump vessel 14. The pump vessel 14 has a cylindrical shape as a whole and has a step 14-1 in its middle portion. A side wall 14a of the upper-side portion of the pump vessel 14 forms a cylindrical portion having a large diameter. Baffles 15 are arranged in an intake gas opening formed in the top portion of the pump vessel 14.

A first cryopanel 16 in the form of a shield vessel arranged along the side wall 14a and the intermediate step portion 14-1 is provided inside the pump vessel 14. The first cryopanel 16 is attached to a refrigerator first stage 17a. Note that the above-described baffles 15 are attached to the opening in the top portion of the first cryopanel 16 in FIG. 1.

A second cryopanel 18 is provided around the central axis portion of the pump vessel 14. The second cryopanel 18 is attached to a refrigerator second stage 17b. The refrigerator first stage 17a and refrigerator second stage 17b are the cryogenic stage portions of a refrigerator 17 provided under the cryopump 13.

A cylindrical low-temperature expansion chamber 17-1 of the refrigerator 17 provided under the cryopump 13 is attached to the central axis in the pump vessel 14. Referring to FIG. 1, the above-described refrigerator second stage 17b is provided at the upper end of the low-temperature expansion chamber 17-1, and the above-described refrigerator first stage 17a is provided at the lower end of the low-temperature expansion chamber 17-1. Helium gas compressed by an external compression unit 19 is supplied to the refrigerator 17 (an arrow 19a). The compressed helium gas supplied to the refrigerator 17 expands in the low-temperature expansion chamber 17-1, and is then recovered by the compression unit 19 (an arrow 19b). After that, the helium gas is compressed again by the compression unit 19 and supplied to the refrigerator 17. When helium gas repeatedly expands in the low-temperature expansion chamber 17-1 of the refrigerator 17 based on the above-described repetitive circulation operation of helium gas, each of the refrigerator first stage 17a and refrigerator second stage 17b is cooled to a predetermined temperature.

The cooling operation of the first and second cryopanels 16 and 18 in the cryopump 13 based on the refrigerator 17 (including the operation of the compression unit 19) is controlled by the control device 30.

A vacuum gauge 20 is provided to the pump vessel 14 of the cryopump 13. The internal pressure of the pump vessel 14 is detected by the vacuum gauge 20. The pressure information of the interior of the pump vessel 14 detected by the vacuum gauge 20 is supplied to the control device 30.

In addition, a purge gas supply mechanism 21 is provided to the pump vessel 14 of the cryopump 13. In the purge gas supply mechanism 21, a drying purge gas is introduced into the pump vessel 14 from a purge gas supply unit (not shown) via a purge gas valve 22. A purge gas is introduced when the purge gas valve 22 is open. A purge gas is an inert gas such as nitrogen gas. The opening/closing operation of the purge gas valve 22 is controlled by the control device 30.

Furthermore, a relief valve 23 for purging a gas in the pump vessel 14 is provided to the pump vessel 14 of the cryopump 13. A vacuum pump 25 is also provided to the pump vessel 14 via a valve 24 for vacuum-exhausting a gas in the pump vessel 14. The relief valve 23 is a differential pressure regulating valve which opens when the internal pressure of the pump vessel 14 has become higher than the atmospheric pressure. When the valve 24 is opened while the vacuum pump 25 is actuated, the interior of the pump vessel 14 is vacuum-evacuated. The operation of the vacuum pump 25 and the opening/closing operation of the valve 24 are controlled by the control device 30.

A temperature sensor 26 such as a thermocouple is provided in the pump vessel 14 of the cryopump 13. This temperature sensor 26 detects the temperature information (Celsius degree) of the interior of the pump vessel 14, and particularly, that of the first cryopanel 16 or the second cryopanel 18. Temperature information detected by the temperature sensor 26 is supplied to the control device 30.

A heater 27 is provided in the outer periphery of the pump vessel 14. The heater 27 is a means for forcibly heating the pump vessel 14. AC power for heating is supplied from an AC power supply 28 to the heater 27. An operation of supplying power from the AC power supply 28 to the heater 27 is performed at a timing when it is necessary. The power supply operation of the AC power supply 28 is controlled by the control device 30.

An absorbent 29 (activated carbon) is provided in the periphery of the low-temperature expansion chamber 17-1 inside the second cryopanel 18.

The operation of the cryopump unit 11 having the above-described components will be described next. A refrigeration operation for vacuum-evacuation will be described first.

In order to vacuum-evacuate the interior of the vacuum processing apparatus 10, the cryopump 13 is caused to perform a refrigeration operation. Upon vacuum-evacuating the interior of the vacuum processing apparatus 10, the main valve 12 is kept open and a compressed helium gas is repetitively supplied to the refrigerator 17 and repetitively expanded in the low-temperature expansion chamber 17-1 so that each of the refrigerator first stage 17a and refrigerator second stage 17b is cooled to a predetermined low temperature. The refrigerator first stage 17a is cooled to about 70K to 90K, and the refrigerator second stage 17b is cooled to a cryogenic temperature of about 10K to 20K. Accordingly, the first cryopanel 16 attached to the refrigerator first stage 17a and baffles 15 are cooled to 70K to 90K, while the second cryopanel 18 attached to the refrigerator second stage 17b is cooled to a cryogenic temperature of 10K to 20K.

During the cooling operation in the cryopump 13 based on the refrigeration effect of the refrigerator 17, of a gas flowing from the intake gas opening of the pump vessel 14 into its inside, water vapor having a high condensation temperature condenses mainly by the baffles 15 and the first cryopanel 16. In this state, water is in a state of ice (solid). A gas such as oxygen, nitrogen, argon, or the like having a lower condensation temperature than water vapor condenses on the second cryopanel 18. Note that a gas such as hydrogen or helium having a further lower condensation temperature is absorbed by the absorbent 29 provided inside the second cryopanel 18. In this manner, various kinds of gases existing in the vacuum processing apparatus 10 are stored in the pump vessel 14 of the cryopump 13 by condensation or absorption.

As described above, when gas molecules are condensed or absorbed by the first and second cryopanels 16 and 18 and the like in the refrigeration operation of the cryopump 13, it becomes possible to exhaust gases existing in the vacuum processing apparatus 10 and make a required vacuum state. However, as the amount of condensed substances in the pump vessel 14 of the cryopump 13 increases, the exhaust speed of the gas from the vacuum processing apparatus 10 decreases, and therefore a required pressure cannot be obtained. To solve this problem, the regeneration processing of the cryopump 13 is performed.

The operation of the regeneration processing in the cryopump 13 will be described next.

The operation of the regeneration processing will be described with reference to FIG. 2. The process of the regeneration processing operation is performed by executing a regeneration processing program 32 stored in a memory 31 of the control device 30.

First, the vacuum evacuation operation of the cryopump 13 is stopped (step S11).

More specifically, the main valve 12 provided between the pump vessel 14 of the cryopump 13 and the vacuum processing apparatus 10 is closed and, at the same time, the operation of the refrigerator 17 for cooling the first and second cryopanels 16 and 18 in the pump vessel 14 is stopped.

Next, the purge gas valve 22 of the drying purge gas supply mechanism 21 is opened and a purge gas is introduced into the pump vessel 14 of the cryopump 13 (step S12). When the purge gas is introduced into the pump vessel 14, a vacuum in the pump vessel 14 is broken and the temperatures of the first and second cryopanels 16 and 18 in the pump vessel 14 rise by the heat of the drying purge gas (a temperature rising step). In this case, AC power is supplied from the AC power supply 28 to the heater 27 to cause the heater 27 to generate a heat, as needed. When the pump vessel 14 is externally heated by the heater 27, the temperature rises of the first and second cryopanels 16 and 18 in the pump vessel 14 are accelerated. With this operation, gas molecules condensed by the first and second cryopanels 16 and 18 vaporize and turn into a gas. For raising the temperatures of the first and second cryopanels 16 and 18, any one of introducing a purge gas, heating by a heater, and leaving them to stand, or any combination of these methods can be utilized.

In the above-described state, when the internal pressure of the pump vessel 14 has become higher than the atmospheric pressure, the relief valve 23 opens. The purge gas or various kinds of gases generated upon vaporization are discharged from the pump vessel 14 to its outside via the relief valve 23.

Next, the control device 30 receives the information of a temperature T of the second cryopanel 18 detected by the temperature sensor 26, and determines whether the temperature T is higher than a set temperature T1 (step S15). The set temperature T1 is “room temperature”.

When the temperature T is determined to be lower than the set temperature T1 in step S15 (NO in step S15), step S15 is repeated while the discharge of the purge gas and the like is continued. Note that in this case, the introduction of the purge gas by the purge gas supply mechanism 21 is continued.

On the other hand, when the temperature T is determined to be higher than the set temperature T1 in step S15 (YES in step S15), the purge gas valve 22 of the purge gas supply mechanism 21 is closed and the introduction of the purge gas into the pump vessel 14 is stopped (step S16). Since the relief valve is open, the internal pressure of the pump vessel 14 becomes almost equal to the atmospheric pressure. Next, the relief valve is closed. After that, evacuation by the vacuum pump 25 is performed (step S17).

Upon performing evacuation by the vacuum pump 25, the vacuum pump 25 is driven and the valve 24 is opened. At the same time, the relief valve 23 is closed. Since an internal pressure P of the pump vessel 14 of the cryopump 13 is almost equal to the atmospheric pressure in the initial state, evacuation by the vacuum pump 25 causes the internal pressure of the pump vessel 14 to gradually decrease. The change of the internal pressure in the pump vessel 14 is monitored by the control device 30 based on the detection signal of the vacuum gauge 20.

In the process of the regeneration processing operation of the cryopump 13 according to this embodiment, upon performing the above-described evacuation, when the internal pressure P of the pump vessel 14 of the cryopump 13 has reached a set pressure higher than the water vapor pressure (about 610 Pa) at 0° C., the evacuation is stopped and a pressure rise test is performed.

More specifically, step S18 is provided to determine whether the internal pressure P of the pump vessel 14 has reached the set pressure higher than the water vapor pressure at 0° C. or not. When No in step S18, steps S17 and S18 are repeated and the evacuation is continued.

When Yes in step S18, that is, when the internal pressure P of the pump vessel 14 is a value immediately preceding the water vapor pressure at 0° C., the evacuation is stopped (step S19), and the pressure rise test is performed (step S20). After that, whether water remains in the pump vessel 14 or not is determined (step S21).

When the internal pressure of the pump vessel 14 of the cryopump 13 is a value immediately preceding the water vapor pressure at 0° C., if water exists in the pump vessel 14, the temperature of the water is higher than 0° C. and the water is in a liquid state. In this case, the pressure rise test is performed (step S20) while the water existing in the pump vessel 14 is in a liquid state.

The pressure rise test is generally performed by leaving the interior of the pump vessel 14 of the cryopump 13 to stand. If the evacuation is stopped when the internal pressure of the pump vessel 14 has reached the set pressure higher than the water vapor pressure at 0° C., the water existing as a liquid in the pump vessel vaporizes due to a heat transferred from the pump vessel 14 of the cryopump 13 or other portions so that the internal pressure of the pump vessel 14 should rise in the subsequent pressure rise test. Based on this, whether water as a liquid remains in the pump vessel 14 or not can be ensured. Such a state can be observed and ensured by monitoring by the control device 30 the pressure information of the interior of the pump vessel 14 detected by the vacuum gauge 20.

According to “Rikanenpyou”, the water vapor pressure is 610.66 Pa at 0° C. and 656.52 Pa at 1° C. Since there is a difference of 45.86 Pa between them, such a difference can be sufficiently observed with the above-described structure.

Assume that the evacuation is stopped and the pressure rise test is performed when the pressure in the pump vessel is higher than the water vapor pressure at 0° C. In this case, since the temperature of the residual water is high, the temperature difference with a heat source is small and difficult to observe. On the other hand, assume that the evacuation is stopped and the pressure rise test is performed when the pressure in the pump vessel is lower than the water vapor pressure at 0° C. In this case, since the residual water has condensed into ice, the heat intake in the pressure rise test serves as a heat of fusion at 0° C., and no internal pressure rise occurs. Therefore, determination of the presence/absence of the residual water based on the pressure rise becomes difficult. In this respect, stopping the evacuation and performing the pressure rise test when the internal pressure of the pump vessel 14 has reached the set pressure higher than the water vapor pressure at 0° C. is a very effective method that can determine the presence/absence of the residual water accurately and reliably.

Based on the above-described reasons, when it is determined in step S21 that water remains in the pump vessel 14 (YES in step S21), a process for removing water from the pump vessel 14 of the cryopump 13 by heating and vaporizing it is performed. In this embodiment, the process returns to step S12 and the above-described steps S12 to S16 are performed. Note that the process for removing water from the pump vessel 14 by additionally heating and vaporizing it is not limited to this, and a complementary removal process similar to this process may be added.

After steps S15 and S16, evacuation is performed again (step S17). After step S17, steps S18 to S21 are performed as described above.

When the above-described steps S12 to S21 are repeated and the condition of the pressure rise test in step S20 is eventually passed, that is, when NO is determined in step S21, the pump vessel is evacuated to several Pa to 100 Pa (step S22).

After that, a general pressure rise test for determining the presence/absence of leak and the like, that is, a buildup test is performed (step S23). When the buildup test is passed, the refrigerator 17 and the like are actuated and the cryopump 13 is driven to decrease the temperature of each of the first and second cryopanels 16 and 18 to a predetermined temperature (step S24). Thus, the regeneration processing operation is ended.

Changes in the internal pressure of the pump vessel 14 based on the above-described regeneration processing operation are shown in FIG. 3. In the graph of FIG. 3, the abscissa represents time and the ordinate represents pressure. Each of waveforms W1 that repeatedly appear in FIG. 3 represents the result of the pressure rise test performed after each of the above-described repetitive evacuation. Of a plurality of waveforms W1, last waveform W1-1 represents a state in which almost no pressure rise occurs. In the plurality of waveforms W1 before waveforms W1-1, obvious pressure rises appear, and vaporization and removal of water by introducing a purge gas is performed in each case. When waveform W1-1 appears, the regeneration processing is ended.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-337385, filed Dec. 27, 2007, which is hereby incorporated by reference herein in its entirety.

What is claimed is:

1. A regeneration method which is performed in a cryopump including a pump vessel, a cryopanel arranged in the pump vessel, and a refrigerator for cooling the cryopanel, and performs exhaustion by condensing gas molecules containing water vapor on the cryopanel, comprising
a temperature raising step of raising a temperature of the cryopanel so as to vaporize the gas molecules condensed on the cryopanel and discharge them in the pump vessel,
an evacuation step of performing evacuation based on a temperature condition of the cryopanel,
a determination step of determining whether a pressure of an interior of the pump vessel has reached a set pressure higher than a water vapor pressure at 0° C.,
a pressure rise test step of stopping the evacuation and performing a pressure rise test when it is determined that the pressure of the interior of the pump vessel has reached the set pressure in the determination step, and
an observation step of observing residual water based on an internal pressure of the pump vessel during the pressure rise test step.

2. The method according to claim 1, wherein the pressure rise test step is performed while water existing in the pump vessel is in a liquid state.

3. The method according to claim 1, wherein the temperature raising step is performed by any one of introducing a purge gas into the pump vessel, heating by a heater, and leaving the pump vessel to stand as the pressure therein decreases, or a combination of these methods.

4. A method according to claim 1, wherein in the observation step, information about the internal pressure of the pump vessel is detected by a vacuum gauge provided in the pump vessel.

5. A cryopump including a pump vessel, a cryopanel arranged in said pump vessel, a refrigerator for cooling said cryopanel, a vacuum gauge for detecting an internal pressure of said pump vessel, and control means for controlling operations of the overall cryopump, and performing vacuum evacuation of a target apparatus by condensing gas molecules containing water on said cryopanel, wherein said control means comprises:
determination means for determining whether the internal pressure of said pump vessel has reached a set pressure higher than a water vapor pressure at 0° C. based on detection information of said vacuum gauge, at a stage of regeneration processing for raising a temperature of said cryopanel, vaporizing the gas molecules condensed on said cryopanel and discharging them in said pump vessel, and performing evacuation based on a temperature condition of said cryopanel;
test performing means for stopping the evacuation and performing a pressure rise test when it is determined by said determination means that the internal pressure has reached the set pressure; and
observation means for observing residual water based on the internal pressure of said pump vessel during the pressure rise test.

6. A cryopump unit comprising means for controlling a cryopump according to claim 5.

7. A vacuum processing apparatus comprising a cryopump unit according to claim 6.
